(19) United States
(12) Patent Application Publication
(10) Pub. No.: US 2015/0086830 A1
(43) Pub. Date: Mar. 26, 2015

(54) BATTERY MODULE HAVING THERMALLY CONDUCTIVE HOLDING FRAME

(71) Applicant: UER TECHNOLOGY CORPORATION, Miaoli County (TW)

(72) Inventors: RAY-TANG SUN, Miaoli (TW); TSUNG-HSIEN CHUANG, Miaoli (TW); CHIEN-LUNG CHEN, Miaoli (TW)

(73) Assignee: UER TECHNOLOGY CORPORATION, Miaoli County (TW)

(21) Appl. No.: 14/067,993

(22) Filed: Oct. 31, 2013

(30) Foreign Application Priority Data
Sep. 25, 2013 (TW) 102134628

(51) Int. Cl. H01M 10/6554

(52) U.S. Cl. CPC H01M 10/5053
USPC 429/120

(57) ABSTRACT

A heat-dispersing battery module includes a top holding frame, a bottom holding frame, and a number of batteries. The top holding frame is made of thermally conductive plastic, and defines a plurality of top receiving holes. The thermally conductive plastic includes a plastic material and a thermally conductive material dispersed in the plastic material, where a thermal conductivity coefficient of the thermally conductive plastic exceeds 3 w/mk. The bottom holding frame is connected to and spaced from the top holding frame, the bottom holding frame defines a number of bottom receiving holes each of which being aligned with a top receiving hole. Each battery includes an anode and a cathode. The batteries are positioned between the top holding frame and the bottom holding frame with the anodes of the batteries received in the top receiving holes and the cathodes of the batteries received in the bottom receiving holes.

### CROSS REFERENCE

This application claims the benefit of co-pending U.S. Application filed by the applicant or assignee of the present invention simultaneously with the present application: U.S. Ser. No. 53,928, which is hereby incorporated herein. The co-pending application is temporarily identified by its docket number. This will be replaced by the corresponding USSN when available.

### BACKGROUND

1. Technical Field

The present disclosure relates to a battery module.

2. Description of Related Art

Battery modules including a number of batteries are widely used as a power source to provide power to, for example, electric vehicles. As there are many batteries in a single battery module, heat is generated in the battery module during operation and can render the battery module unreliable and unsafe.

Therefore, it is desirable to provide a battery module which can overcome the shortcomings mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of a battery module according to a first embodiment of the present disclosure.

FIG. 2 is a partially exploded view of the battery module of FIG. 1.

FIG. 3 is similar to FIG. 2, but viewed from another angle.

FIG. 4 is a schematic, isometric view of the battery module of FIG. 1 without a heat dissipating plate, top electric conductive pieces, a first and a second top electric conductive strips, bottom electric conductive pieces, and a first and a second bottom electric conductive strips.

FIG. 5 is a schematic, isometric view of the battery module of FIG. 4 with batteries removed.

FIG. 6 is an exploded view of the battery module of FIG. 5.

FIG. 7 is an exploded view of a top holding frame of the battery module of FIG. 5.

FIG. 8 is an exploded view of a bottom holding frame of the battery module of FIG. 5.

FIG. 9 is a schematic, isometric view of a first supporting plate of the battery module of FIG. 5.

FIG. 10 is a schematic, isometric view of a second supporting plate of the battery module of FIG. 5.

FIG. 11 is a partially exploded view of a battery module according to a second embodiment of the present disclosure.

FIG. 12 is a schematic view showing components of a thermally conductive plastic according to a third embodiment of the present disclosure.

### DETAILED DESCRIPTION

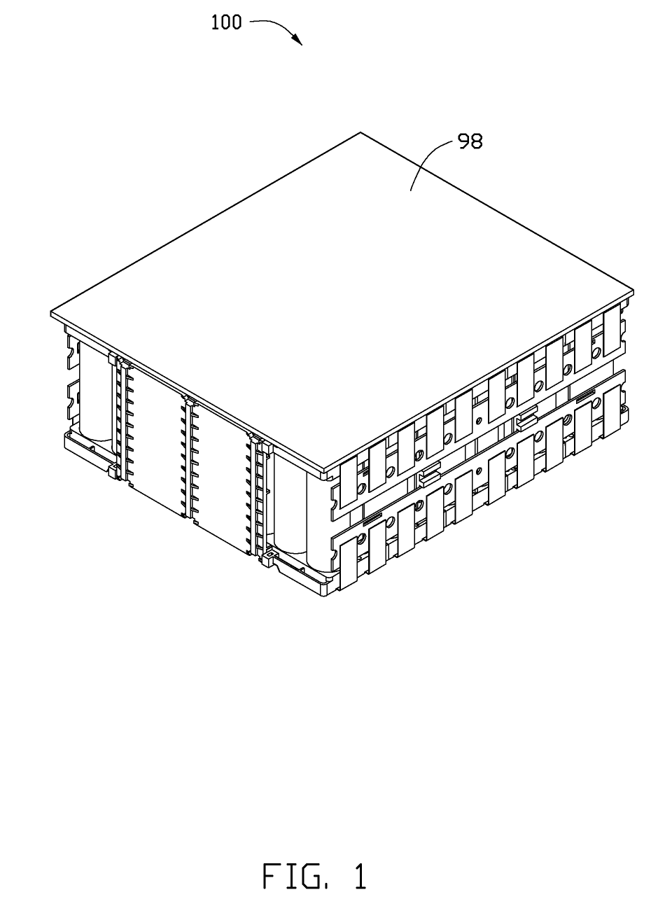

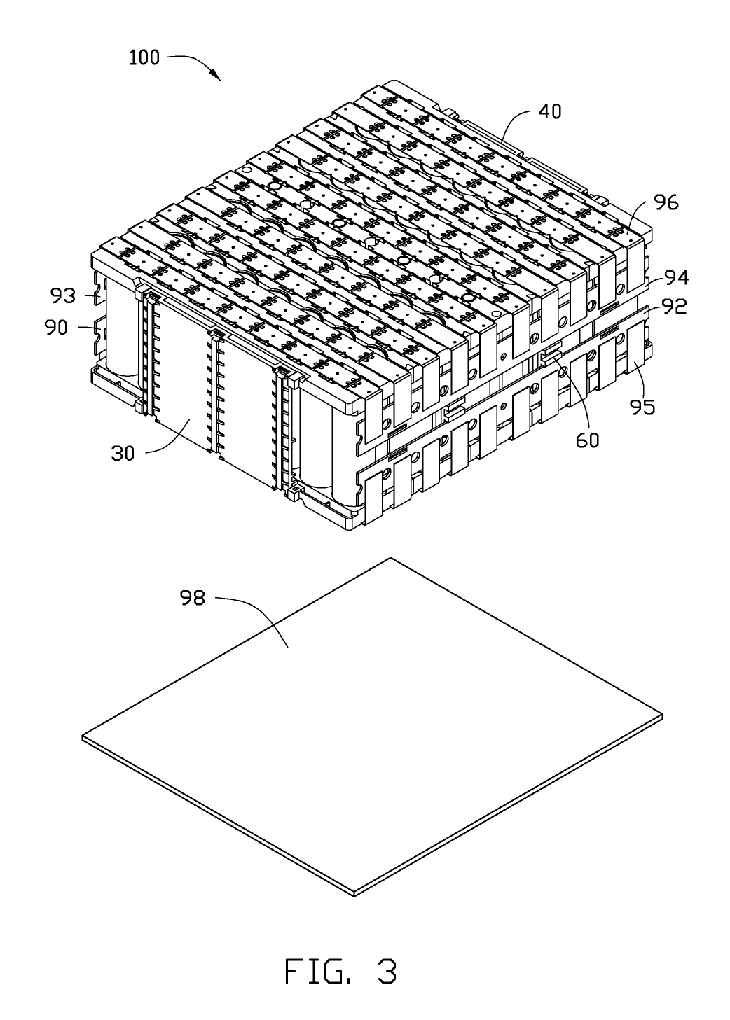

Referring to FIGS. 1 to 4, a battery module 100 according to a first embodiment of the present disclosure is shown. The battery module 100 includes a top holding frame 10, a bottom holding frame 20, a first supporting plate 30, a second supporting plate 40, two first supporting rods 50, two second supporting rods 60, a reinforcing plate 70, a number of batteries 80, a first top electric conductive strip 90, a second top electric conductive strip 92, a first bottom electric conductive strip 93, a second bottom electric conductive strip 94, a number of top electric conductive pieces 95, a number of bottom conductive pieces 96, and a heat dissipating plate 98.

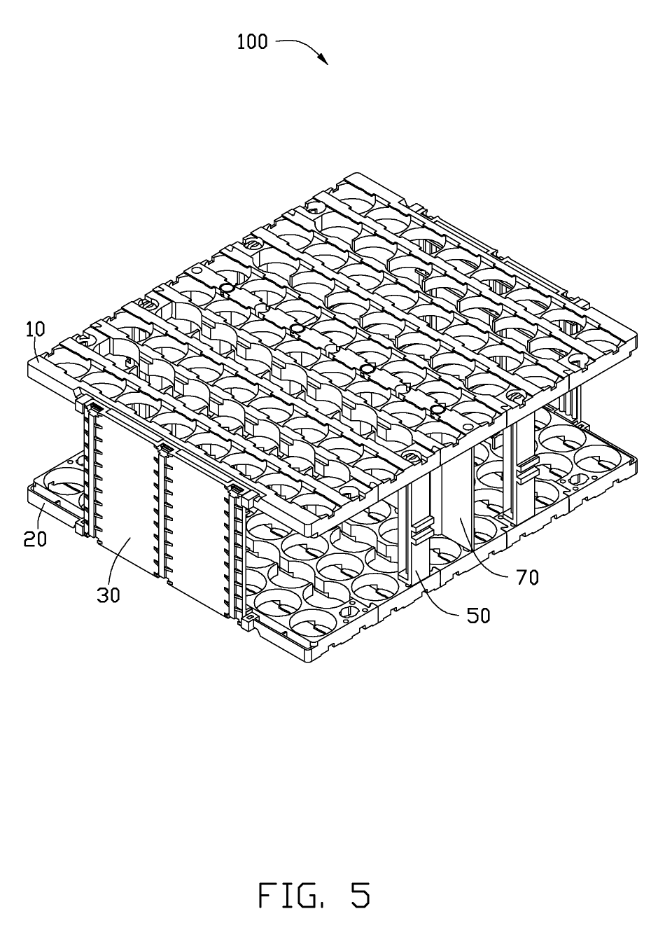

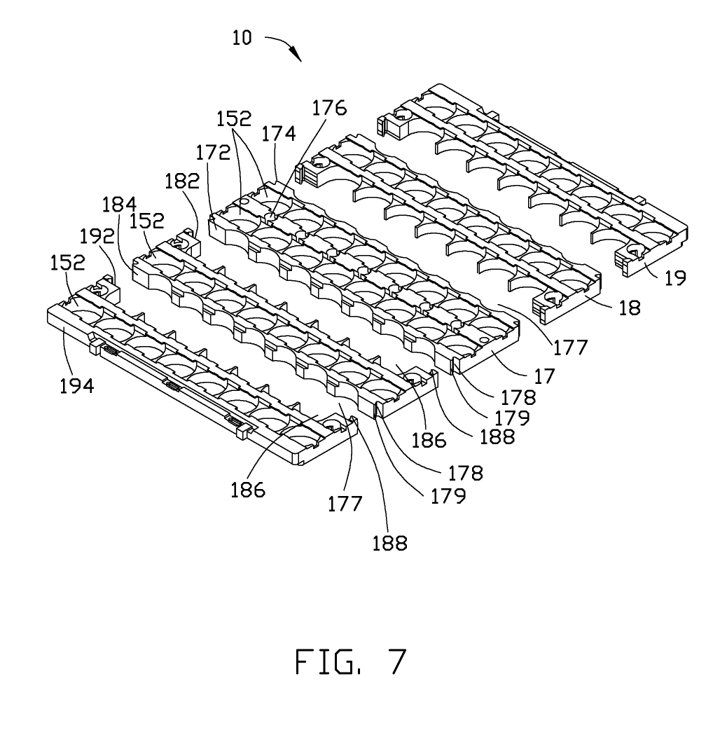

Also referring to FIGS. 5 to 7, the top holding frame 10 is substantially rectangular and is made of thermally conductive plastic. The top holding frame 10 is electrically non-conductive and elastic. The top holding frame 10 includes a first sidewall 11, a second sidewall 12, a third sidewall 13 and a fourth sidewall 14. The first sidewall 11 is opposite and parallel to the second sidewall 12. The third sidewall 13 is opposite and parallel to the fourth sidewall 14. The first sidewall 11 and the second sidewall 12 are perpendicular to the third sidewall 13 and the fourth sidewall 14. The first sidewall 11, the second sidewall 12, the third sidewall 13, and the fourth sidewall 14 are connected end to end with each other. The first sidewall 11 defines three first top clamping holes 110. The three first top clamping holes 110 are arranged in a line along a direction from the fourth sidewall 14 to the third sidewall 13. The second sidewall 12 defines three second top clamping holes 120. The three second top clamping holes 120 are arranged in a line along a direction from the fourth sidewall 14 to the third sidewall 13.

The top holding frame 10 further includes a top surface 10a and a bottom surface 10b. The top surface 10a is opposite and parallel to the bottom surface 10b. The top holding frame 10 defines a number of top receiving holes 15 extending through the top surface 10a and the bottom surface 10b. The top receiving holes 15 include a number of first top receiving hole groups 152 and a number of second top receiving hole groups 154. Each first top receiving hole group 152 includes a number of top receiving holes 15 arranged in a line along a direction from the third sidewall 13 to the fourth sidewall 14. Each second top receiving hole group 154 includes a number of top receiving holes 15 arranged in a line along a direction from the third sidewall 13 to the fourth sidewall 14. The top receiving holes 15 of the first top receiving hole groups 152 are offset relative to the top receiving holes 15 of the second top receiving hole groups 154. A number of buffering boards 16 corresponding one-to-one to the top receiving holes 15 are formed on the top surface 10a. Each buffering board 16 extends into a top receiving hole 15 and partly covers the top receiving hole 15. In this embodiment, there are six first top receiving hole groups 152 and four second top receiving hole groups 154. Each first top receiving hole group 152 includes eight top receiving holes 15. Each second top receiving hole group 154 includes seven top receiving holes 15. The line along which the top receiving holes 15 of the first top receiving hole group 152 are arranged is parallel to the line along which the top receiving holes 15 of the second top receiving hole group 154 are arranged.

In this embodiment, the top holding frame 10 is detachable, and includes a middle part 17, two connecting parts 18 and two end parts 19. The two connecting parts 18 are detachably mounted on two opposite sides of the middle part 17. The two connecting parts 18 and the middle part 17 are arranged between the two end parts 19. The two end parts 19 are detachably mounted on the two connecting parts 18.

In detail, the middle part 17 includes a first side surface 172 and an opposite second side surface 174. The middle part 17 defines two first top receiving hole groups 152, four fixing holes 176, fourteen first notches 177 and four clamping grooves 178. The two top receiving hole groups 152 are located between the first side surface 172 and the second side surface 174. The four fixing holes 176 are located between the two top receiving hole groups 152. The four fixing holes 176 are arranged along a line from the third sidewall 13 to the fourth sidewall 14. The fourteen first notches 177 are evenly formed at the first side surface 172 and the second side surface 174. The four clamping grooves 178 are located at the four corners of the middle part 17. The middle part 17 further includes four limiting hooks 179 corresponding to the four clamping grooves 178. Each limiting hook 179 extends into a groove 178.

Each connecting part 18 includes a third side surface 182 and an opposite fourth side surface 184, and defines one first top receiving hole group 152, seven first notches 177, seven second notches 186 and two clamping grooves 178. The first top receiving hole group 152 is located between the third side surface 182 and the fourth side surface 184. The seven first notches are defined at the fourth side surface 184. The seven second notches are defined at the third side surface 182. The two clamping grooves 178 are located at opposite ends of the fourth side surface 184. Each connecting part 18 further includes two limiting hooks 179 corresponding to the two clamping grooves 178 and two clamping hooks 188 corresponding to the two limiting hooks 179. Each limiting hook 179 extends into a clamping groove 178. The two clamping hooks 188 extend outwardly from two ends of the third side surface 182.

Each end part 19 includes a fifth side surface 192 and an opposite sixth side surface 194. One sixth side surface 194 of one end part 19 is an outer surface of the first sidewall 11. One sixth side surface 194 of the other end part 19 is an outer surface of the second sidewall 12. The end part 19 includes one first top receiving hole group 152 and seven second notches 186. The first top receiving hole group 152 is located between the fifth side surface 192 and the sixth side surface 194. The seven second notches 186 are defined at the fifth side surface 192. Each end part 19 further includes two clamping hooks 188. The two clamping hooks 188 extend outwardly from two ends of the fifth side surface 192.

When assembling, first, the clamping hooks 188 at the third side surface 182 are received in the clamping grooves 178 of the middle part 17 and engage with the limiting hooks 179 to mount the two connecting parts 18 on the first side surface 172 and the second side surface 174 of the middle part 17. Then the clamping hooks 188 at the fifth side surface 192 are received in the clamping grooves 178 at the fourth side surface 184 and engage with the limiting hooks 179 to mount the two end parts 19 on the fourth side surface 184 of the two connecting parts 18. At this time, each second notch 186 in the connecting part 18 and the corresponding first notch 177 in the middle part 17 are aligned with each other and cooperatively form a top receiving hole 15 of the second top receiving hole group 154, and each first notch 177 in the connecting part 18 and the corresponding second notch 186 in the end part 19 are aligned with each other and cooperatively form a top receiving hole 15 of the second top receiving hole group 154. Because the top holding frame 10 is elastic, the clamping hooks 188 can elastically deform to disengage from the limiting hooks 179 to disassemble the middle part 17, the two connecting parts 18, and the two end parts 19.

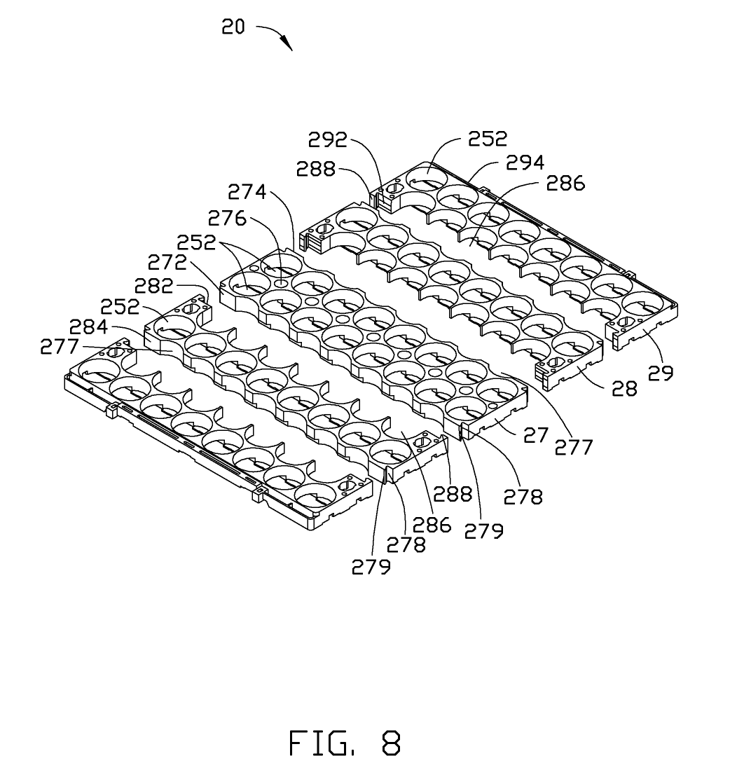

Referring to FIGS. 5, 6, and 8, the structure of the bottom holding frame 20 is substantially the same the structure of the top holding frame 10. The bottom holding frame 20 is substantially rectangular and is elastic. The bottom holding frame 20 includes a first sidewall 21, a second sidewall 22, a third sidewall 23, and a fourth sidewall 24. The first sidewall 21 is opposite and parallel to the second sidewall 22. The third sidewall 23 is opposite and parallel to the fourth sidewall 24. The first sidewall 21 and the second sidewall 22 are perpendicular to the third sidewall 23 and the fourth sidewall 24. The first sidewall 21, the second sidewall 22, the third sidewall 23, and the fourth sidewall 24 are connected end to end with each other. The first sidewall 21 defines three first bottom clamping holes 210. The three first bottom clamping holes 210 are arranged in a line along a direction from the fourth sidewall 24 to the third sidewall 23. The second sidewall 22 defines three second bottom clamping holes 220. The three second bottom clamping holes 220 are arranged in a line along a direction from the fourth sidewall 24 to the third sidewall 23.

The bottom holding frame 20 further includes a top surface 20a and a bottom surface 20b. The top surface 20a is opposite and parallel to the bottom surface 20b. The bottom holding frame 20 defines a number of bottom receiving holes 25 extending through the top surface 20a and the bottom surface 20b. The bottom receiving holes 25 include a number of first bottom receiving hole groups 252 and a number of second bottom receiving hole groups 254. Each first bottom receiving hole group 252 includes a number of bottom receiving holes 25 arranged in a line along a direction from the third sidewall 23 to the fourth sidewall 24. Each second bottom receiving hole group 254 includes a number of bottom receiving holes 25 arranged in a line along a direction from the third sidewall 23 to the fourth sidewall 24. The bottom receiving holes 25 of the first bottom receiving hole group 252 are offset relative to the bottom receiving holes 25 of the second bottom receiving hole group 254. A number of buffering boards 26 corresponding one-to-one to the bottom receiving holes 25 are formed on the bottom surface 20b. Each buffering board 26 extends into a bottom receiving hole 25 and partly covers the bottom receiving hole 25. In this embodiment, there are six first bottom receiving hole groups 252 and four second bottom receiving hole groups 254. Each first bottom receiving hole group 252 includes eight bottom receiving holes 25. Each second bottom receiving hole group 254 includes seven bottom receiving holes 25. The line along which the bottom receiving holes 25 of the first bottom receiving hole group 252 are arranged is parallel to the line along which the bottom receiving holes 25 of the second bottom receiving hole group 254 are arranged.

In this embodiment, the bottom holding frame 20 is detachable, and includes a middle part 27, two connecting parts 28, and two end parts 29. The two connecting parts 28 are detachably mounted on opposite sides of the middle part 27. The two connecting parts 28 and the middle part 27 are arranged between the two end parts 29. The two end parts 29 are detachably mounted on the connecting parts 28.

In detail, the middle part 27 includes a first side surface 272 and an opposite second side surface 274. The middle part 27 defines two first bottom receiving hole groups 252, four fixing holes 276, fourteen first notches 277, and four clamping grooves 278. The two bottom receiving hole groups 252 are located between the first side surface 272 and the second side surface 274. The four fixing holes 276 are located between the two bottom receiving hole groups 252. The four fixing holes 276 are arranged along a line from the third sidewall 23 to the fourth sidewall 24. The fourteen first notches 277 are evenly formed at the first side surface 272 and the second side surface 274. The four clamping grooves 278 are located at the four corners of the middle part 27. The middle part 27 further includes four limiting hooks 279 corresponding to the four clamping grooves 278. Each limiting hook 279 extends into a groove 278.

Each connecting part 28 includes a third side surface 282 and an opposite fourth side surface 284, and defines one first bottom receiving hole group 252, seven first notches 277, seven second notches 286 and two clamping grooves 278. The first bottom receiving hole group 252 is located between the third side surface 282 and the fourth side surface 284. The seven first notches 277 are defined at the fourth side surface 284. The seven second notches 286 are defined at the third side surface 282. The two clamping grooves 278 are located at opposite ends of the fourth side surface 284. Each connecting part 28 further includes two limiting hooks 279 corresponding to the two clamping grooves 278 and two clamping hooks 288 corresponding to the two limiting hooks 279. Each limiting hook 279 extends into a clamping groove 278. The two clamping hooks 288 extend outwardly from two ends of the third side surface 282.

Each end part 29 includes a fifth side surface 292 and an opposite sixth side surface 294. The sixth side surface 294 is an outer surface of the first sidewall 21 or of the second sidewall 22. The end part 29 includes one first bottom receiving hole group 252 and seven second notches 286. The first bottom receiving hole group 252 is located between the fifth side surface 292 and the sixth side surface 294. The seven second notches 286 are defined at the fifth side surface 292. Each end part 29 further includes two clamping hooks 288. The two clamping hooks 288 extend outwardly from two ends of the fifth side surface 292.

When assembling, first, the clamping hooks 288 at the third side surface 282 are received in the clamping grooves 278 of the middle part 27 and engage with the limiting hooks 279 to mount the two connecting parts 28 on the first side surface 272 and the second side surface 274 of the middle part 27. Then the clamping hooks 288 at the fifth side surface 292 are received in the clamping grooves 278 at the fourth side surface 284 and engage with the limiting hooks 279 to mount the two end parts 29 on the fourth side surface 284 of the two connecting parts 28. At this time, each second notch 286 in the connecting part 28 and the corresponding first notch 277 in the middle part 27 are aligned with each other and cooperatively form a bottom receiving hole 25 of the second bottom receiving hole group 254, and each first notch 277 in the connecting part 28 and the corresponding second notch 286 in the end part 29 are aligned with each other and cooperatively form a bottom receiving hole 25 of the second bottom receiving hole group 254. Because the bottom holding frame 20 is elastic, the clamping hooks 288 can elastically deform to disengage from the limiting hooks 279 to disassemble the middle part 27, the two connecting parts 28, and the two end parts 29.

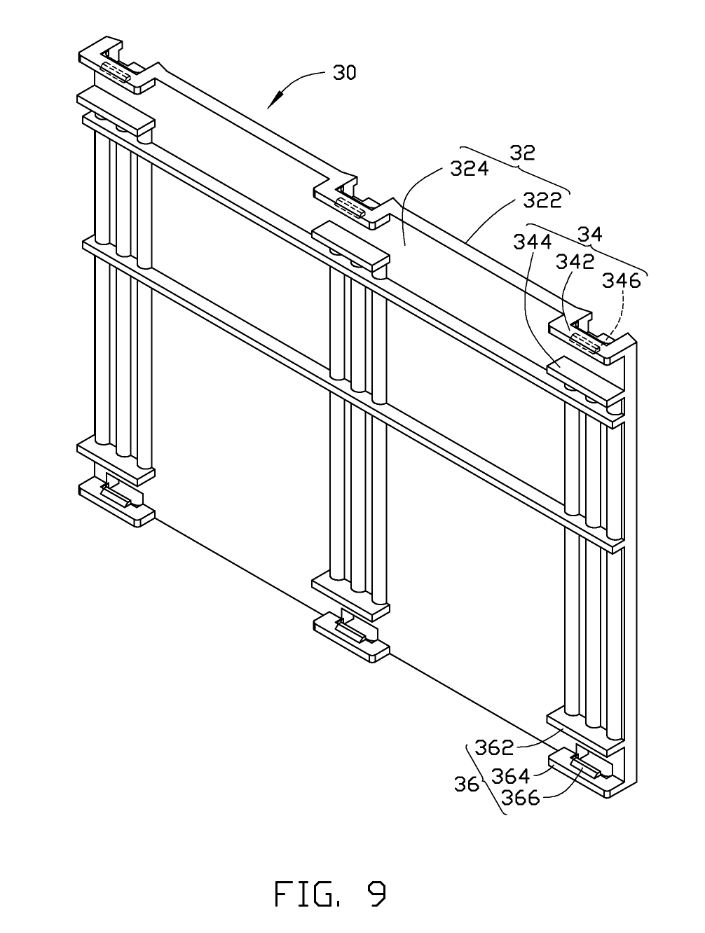

Referring to FIGS. 5, 6, and 9, the first supporting plate 30 includes a first main body 32, three first top clamping portions 34 and three first bottom clamping portions 36. The first main body 32 is substantially a rectangular flat plate, and includes a first surface 322 and an opposite second surface 324. The first top clamping portions 34 and the first bottom portions 36 are formed on the second surface 324. The three first top clamping portions 34 are arranged along a line at the top end of the first main body 32 and correspond one-to-one to the three first top clamping holes 110. The three first bottom clamping portions 36 are arranged along a line at the bottom end of the first main body 32 and correspond one-to-one to the three first bottom clamping holes 210. Each first top clamping portion 34 includes a first top limiting block 342, a second top limiting block 344 spaced from the first top limiting block 342, and a first protrusion 346 projecting from the first top limiting block 342 and facing the second top limiting block 344. Each first bottom clamping portion 36 includes a first bottom limiting block 362, a second bottom limiting block 364 spaced from the first bottom limiting block 362, and a second protrusion 366 projecting from the second bottom limiting block 364 and facing the first bottom limiting block 362.

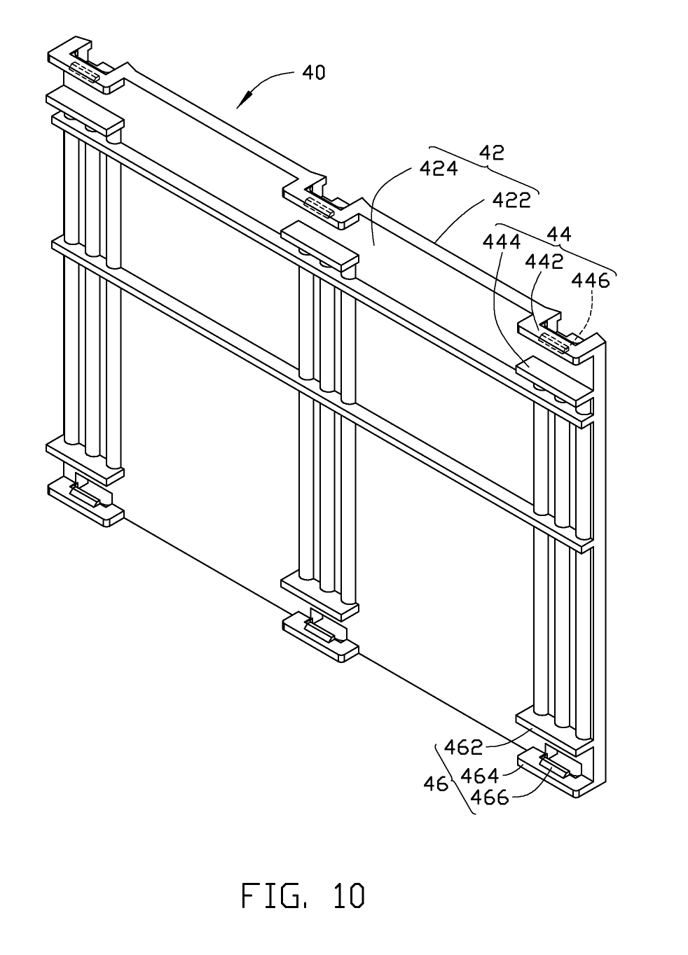

Referring to FIGS. 5, 6, and 10, the structure of the second supporting plate 40 is substantially the same the structure of the first supporting plate 30. The second supporting plate 40 includes a first main body 42, three first top clamping portions 44 and three first bottom portions 46. The first main body 42 is substantially a rectangular flat plate, and includes a first surface 422 and an opposite second surface 424. The first top clamping portions 44 and the first bottom portions 46 are formed on the second surface 424. The three first top clamping portions 44 are arranged along a line at the top end of the first main body 42 and correspond one-to-one to the three second top clamping holes 210. The three first bottom clamping portions 46 are arranged along a line at the bottom end of the first main body 42 and correspond one-to-one to the three second bottom clamping holes 220. Each first top clamping portion 44 includes a first top limiting block 442, a second top limiting block 444 spaced from the first top limiting block 442, and a first protrusion 446 projecting from the first top limiting block 442 and facing the second top limiting block 444. Each first bottom clamping portion 46 includes a first bottom limiting block 462, a second bottom limiting block 464 spaced from the first bottom limiting block 462, and a second protrusion 466 projecting from the second bottom limiting block 464 and facing the first bottom limiting block 462.

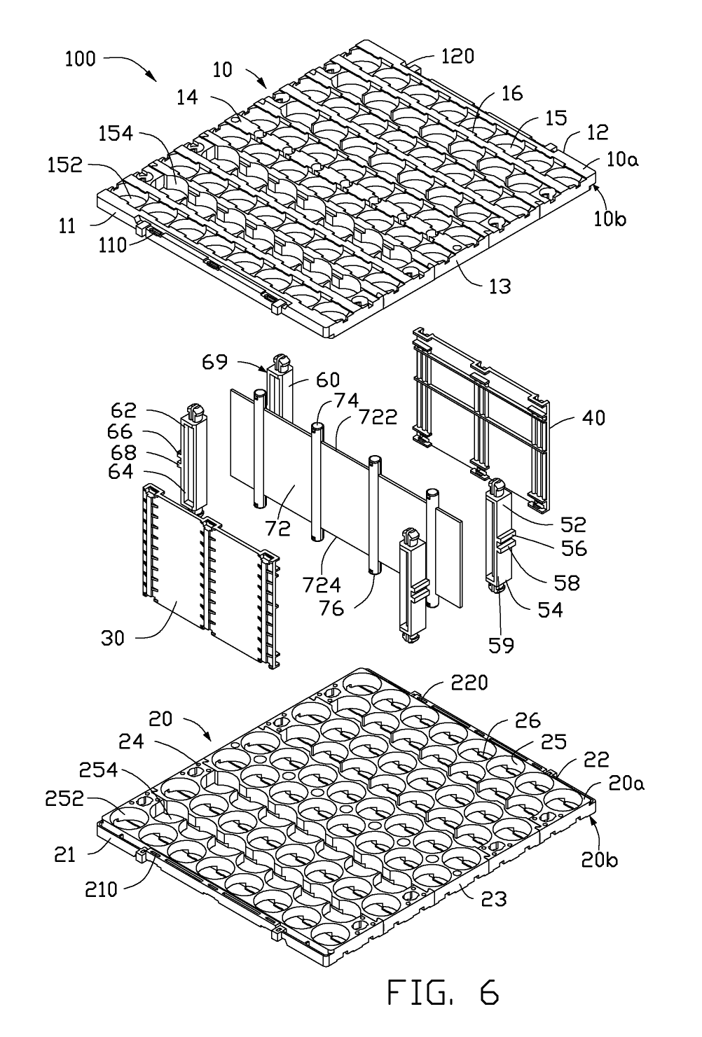

Referring to FIG. 6, each first supporting rod 50 includes a first top end 52, a first bottom end 54, a first limiting piece 56, a second limiting piece 58, and a first outer side surface 59. The first limiting piece 56 projects from the first outer side surface 59 at the first top end 52. The second limiting piece 58 projects from the first outer side surface 59 at the first bottom end 54.

The structure of the second supporting rod 60 is substantially the same the structure of the first supporting rod 50. Each second supporting rod 60 includes a first top end 62, a first bottom end 64, a first limiting piece 66, a second limiting piece 68, and a first outer side surface 69. The first limiting piece 66 projects from the first outer side surface 69 at the first top end 62. The second limiting piece 68 projects from the first outer side surface 69 at the first bottom end 64.

The reinforcing plate 70 includes a body 72, four top fixing rods 74, and four bottom fixing rods 76. The body 72 includes a top end 722 and an opposite bottom end 724. The four top fixing rods 74 extend perpendicularly from the top end 722 and correspond to the four fixing holes 176. The four bottom fixing rods 76 extend perpendicularly from the bottom end 724 and correspond to the four fixing holes 276.

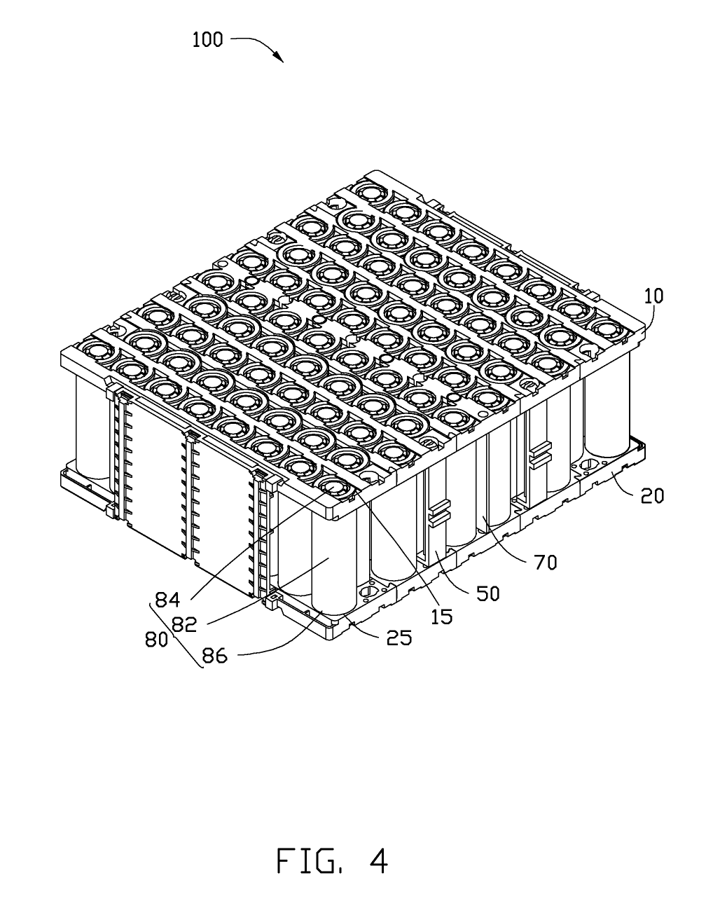

Referring to FIG. 4, each battery 80 includes a shell 82, an anode 84 and a cathode 86. The anode 84 and the cathode 86 are positioned at opposite ends of the shell 82.

Referring to FIGS. 4 to 6, when loading the batteries 80, first, the top holding frame 10 and the bottom holding frame 20 are integrally assembled according to the method mentioned above. Second, the cathodes 86 of the batteries 80 are inserted into the bottom receiving holes 25 and are supported by the buffering boards 26. The first bottom ends 54 of the two first supporting rods 50 are fixedly inserted into holes (not labeled) defined in the third sidewall 23. The first bottom ends 64 of the two second supporting rods 60 are fixedly inserted into holes (not labeled) defined in the fourth sidewall 23. The four bottom fixing rods 76 are fixedly inserted into the four fixing holes 276. The first outer side surfaces 59, 69 face outward and are opposite to the batteries 80. Third, the top holding frame 10 is moved above the bottom holding frame 20. The anodes 84 of the batteries 80 are received in the top receiving holes 15 and are limited by the buffering boards 16. The first top ends 52 of the two first supporting rods 50 are fixedly inserted into holes (not labeled) defined in the third sidewall 13. The first top ends 62 of the two second supporting rods 60 are fixedly inserted into holes (not labeled) defined in the fourth sidewall 14. The four top fixing rods 74 are fixedly inserted into the four fixing holes 176. The top receiving holes 15 are each aligned with a bottom receiving hole 25. The first sidewalls 11, 21 are aligned with each other. The second sidewalls 12, 22 are aligned with each other. The third sidewalls 13, 23 are aligned with each other. The fourth sidewalls 14, 24 are aligned with each other. Finally, the first sidewall 11 is clamped by the first top limiting blocks 342 and the second top limiting blocks 344. The first protrusions 346 are engaged with the first top clamping holes 110. The first sidewall 21 is clamped by the first bottom limiting blocks 362 and the second bottom limiting blocks 364. The second protrusions 366 are engaged with the first bottom clamping holes 210. The second sidewall 12 is clamped by the first top limiting blocks 442 and the second top limiting blocks 444. The first protrusions 446 are engaged with the second top clamping holes 210. The second sidewall 22 is clamped by the first bottom limiting blocks 462 and the second bottom limiting blocks 464. The second protrusions 466 are engaged with the second bottom clamping holes 220. In this way, the top holding frame 10 and the bottom holding frame 20 are fixedly connected together and are spaced from each other. In another embodiment, the first supporting rods 50, the second supporting rods 60, and the reinforcing plate 70 can be removed, and then the top holding frame 10 would be connected to the bottom holding frame only by the first supporting plate 30 and the second supporting plate 40.

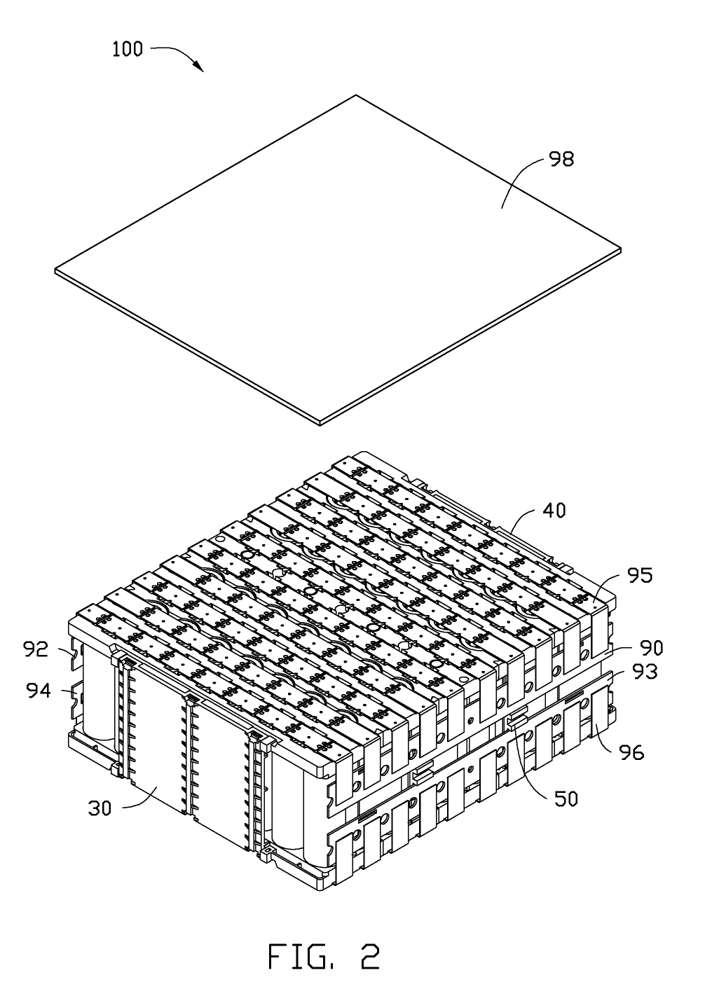

Referring to FIGS. 2, 5, and 6, the first top electric conductive strip 90, the second electric conductive strip 92, the first bottom electric conductive strip 93, the second bottom electric conductive strip 94, the top electric conductive pieces 95, and the bottom electric conductive pieces 96 are made of copper.

The first top electric conductive strip 90 is supported by the two first limiting pieces 56 and is adhered to the two first outer side surfaces 59. The first top electric conductive strip 90 is located at the first top end 52. A length of the first top electric conductive strip 90 is equal a length of the third sidewall 13. The second top electric conductive strip 92 is supported by the two first limiting pieces 66 and is adhered to the two first outer side surfaces 69. The second top electric conductive strip 92 is located at the first top end 62. A length of the second top electric conductive strip 92 is equal a length of the fourth sidewall 14. The first bottom electric conductive strip 93 is supported by the two second limiting pieces 58 and is adhered to the two first outer side surfaces 59. The first bottom electric conductive strip 93 is located at the first bottom end 54. A length of the first bottom electric conductive strip 93 is equal a length of the third sidewall 23. The second bottom electric conductive strip 94 is supported by the two second limiting pieces 68 and is adhered to the two first outer side surfaces 69. The second bottom electric conductive strip 94 is located at the first bottom end 64. A length of the second bottom electric conductive strip 94 is equal a length of the fourth sidewall 24.

The anodes 84 received in the same first top receiving hole group 152 are connected in parallel by the top electric conductive pieces 95. The anodes 84 received in the same second top receiving hole group 154 are connected in parallel by the top electric conductive pieces 95. The anode 84 adjacent to the third sidewall 13 is connected to the first top electric conductive strip 90 by the top electric conductive piece 95. The anode 84 adjacent to the fourth sidewall 14 is connected to the second top electric conductive strip 92 by the top electric conductive piece 95. The cathodes 86 received in the same first bottom receiving hole group 252 are connected in parallel by the bottom electric conductive pieces 96. The cathodes 86 received in the same second bottom receiving hole group 254 are connected in parallel by the bottom electric conductive pieces 96. The cathode 86 adjacent to the third sidewall 23 is connected to the first bottom electric conductive strip 93 by the bottom electric conductive piece 96. The cathode 86 adjacent to the fourth sidewall 24 is connected to the second bottom electric conductive strip 94 by the bottom electric conductive piece 96.

Referring to FIGS. 1, 2 and 6, the heat dissipating plate 98 is adhered to the top surface 10a of the top holding frame 10. The heat dissipating plate 98 is made of thermally conductive silicon rubber.

When working, the anodes 84 of the batteries 80 produce heat. The anodes 84 are received in the top receiving holes 15 and are in contact with the top holding frame 10. Because the top holding frame 10 is made of thermally conductive plastic, the top holding frame 10 transfers the heat from the anodes 84 to the heat dissipating plate 98 for dissipation. The heat will not remain in the battery module 100, thus ensuring normal and safe working of the battery module 100. As it is the top holding frame 10 which is used to transfer heat, no other heat transferring mechanism is required. Thus, the battery module 100 is simplified in structure and reduced in volume.

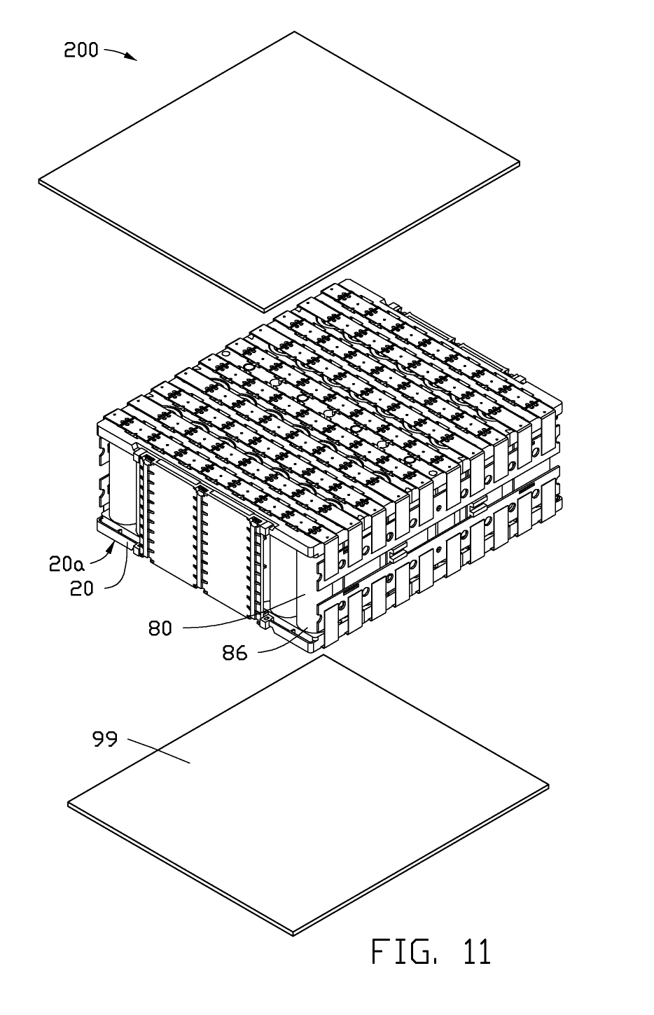

Referring to FIG. 11, a battery module 200 according to a second embodiment of the present disclosure is disclosed. The battery module 200 is similar to the battery module 100 except that a bottom holding frame 20 of the battery module 200 is also made of thermally conductive plastic and the battery module 200 further includes a heat dissipating plate 99 adhered to the bottom surface 20b of the bottom holding frame 20. The heat dissipating plate 99 is made of thermally conductive silicon rubber.

In the battery module 200, heat generated by the cathodes 86 is dissipated by the heat dissipating plate 99. Thus, the heat dissipating efficiency of the battery module 200 is further increased.

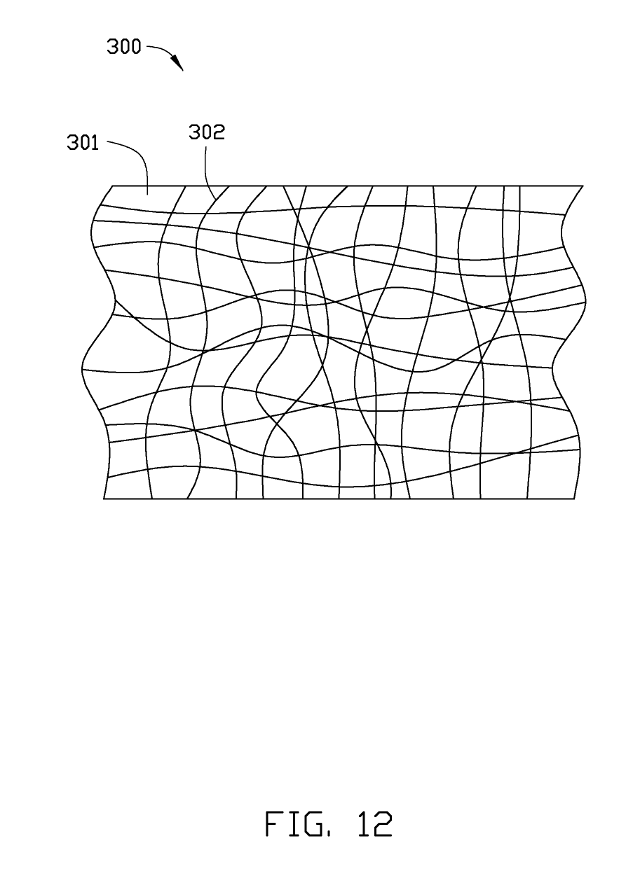

Referring to FIG. 12, a thermally conductive plastic 300 for forming the top holding frame 10 and the bottom holding frame 20 is disclosed. The thermally conductive plastic 300 includes a plastic material 301 and thermally conductive material 302 dispersed in the plastic material 301. The plastic material 301 is a common plastic, such as polyamide or polycarbonate. The thermally conductive material 302 is evenly dispersed in the plastic material 301 to form a thermally conductive network. The thermally conductive material 302 can be carbon, such as graphite fibers or carbon fibers, or can be particles of metallic oxide. In this embodiment, the plastic material 301 is polyamide, and the thermally conductive material 302 is carbon fibers. The weight ratio of the plastic material 301 to the thermally conductive material 302 is 50%-70%: 30%-50%, and a sum of the weight of the plastic material 301 and the thermally conductive material 302 does not exceed the weight of the thermally conductive plastic 300. When the thermally conductive material 302 or the weight ratio of the plastic material 301 to the thermally conductive material 302 varies, the thermal conductivity coefficient of the thermally conductive plastic 300 also varies. In this embodiment, the thermal conductivity coefficient of the thermally conductive plastic 300 exceeds 3 w/mk (watt/(meter*kelvin)).

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A battery module comprising:
a top holding frame made of thermally conductive plastic, the top holding frame defining a plurality of top receiving holes, the thermally conductive plastic comprising a plastic material and a thermally conductive material dispersed in the plastic material, a thermal conductivity coefficient of the thermally conductive plastic being exceeding 3 w/mk;
a bottom holding frame connected to and spaced from the top holding frame, the bottom holding frame defining a plurality of bottom receiving holes aligned with the top receiving holes one by one; and
a plurality of batteries, each battery comprising an anode and a cathode, the batteries being positioned between the top holding frame and the bottom holding frame with the anodes of the batteries received in the top receiving holes and the cathodes of the batteries received in the bottom receiving holes.

2. The battery module of claim 1, further comprising a heat dissipating plate made of thermally conductive silicon rubber and adhered to a surface of the top holding frame away from the batteries.

3. The battery module of claim 2, wherein the top holding frame comprises a plurality of first buffering boards formed on the surface of the top holding frame away from the batteries, each first buffering board extends into and partly covers one of the top receiving holes; and the bottom holding frame comprises a plurality of second buffering boards formed on a surface of the bottom holding frame away from the batteries, each second buffering board extends into and partly covers one of the bottom receiving holes; and the first and second buffering boards prevent the batteries from sliding out of the top and bottom receiving holes.

4. The battery module of claim 2, wherein the top holding frame and the bottom holding frame respectively comprises a first sidewall and a second sidewall opposite to the first sidewall, the battery module further comprise a first supporting plate and a second supporting plate, a top end of the first supporting plate clamps the first sidewall of the top holding frame, a bottom end of the first supporting plate clamps the first sidewall of the bottom holding frame, a top end of the second supporting plate clamps the second sidewall of the top holding frame, and a bottom end of the second supporting plate clamps the second sidewall of the bottom holding frame.

5. The battery module of claim 4, wherein the top end of the first supporting plate comprises a plurality of first top clamping portions, each first top clamping portion comprises a first top limiting block, a second top limiting block spaced from the first top limiting block, and a first protrusion projected from the first top limiting block and adjacent to the second top limiting block; the bottom end of the first supporting plate comprises a plurality of first bottom clamping portions, each first bottom clamping portion comprises a first bottom limiting block, a second bottom limiting block spaced from the first bottom limiting block, and a second protrusion projected from the second bottom limiting block and adjacent to the first bottom limiting block; the first sidewall of the top holding frame defines a plurality of first top clamping holes, the first sidewall of the bottom holding frame defines a plurality of first bottom clamping holes; the first top limiting blocks and the second top limiting blocks clamp the first sidewall of the top holding frame and the first protrusions engage with the first top clamping holes, the first bottom limiting blocks and the second bottom limiting blocks clamp the first sidewall of the bottom holding frame and the second protrusions engage with the first bottom clamping holes.

6. The battery module of claim 4, wherein the top end of the second supporting plate comprises a plurality of first top clamping portions, each first top clamping portion comprises a first top limiting block, a second top limiting block spaced from the first top limiting block, and a first protrusion projected from the first top limiting block and adjacent to the second top limiting block; the bottom end of the second supporting plate comprises a plurality of first bottom clamping portions, each first bottom clamping portion comprises a first bottom limiting block, a second bottom limiting block spaced from the first bottom limiting block, and a second protrusion projected from the second bottom limiting block and adjacent to the first bottom limiting block; the second sidewall of the top holding frame defines a plurality of second top clamping holes, the second sidewall of the bottom holding frame defines a plurality of second bottom clamping holes; the first top limiting blocks and the second top limiting blocks clamp the second sidewall of the top holding frame and the first protrusions engage with the second top clamping holes, the first bottom limiting blocks and the second bottom limiting blocks clamp the second sidewall of the bottom holding frame and the second protrusions engage with the second bottom clamping holes.

7. The battery module of claim 4, wherein the top holding frame and the bottom holding frame each further comprises a third sidewall and a fourth sidewall opposite to the third sidewall, the battery module further comprises two first supporting rods and two second supporting rods, two ends of each the first supporting rod are respectively fixed on the third sidewall of the top holding frame and the third sidewall of the bottom holding frame, two ends of each the second supporting rod are respectively fixed on the fourth sidewall of the top holding frame and the fourth sidewall of the bottom holding frame.

8. The battery module of claim 7, wherein the top receiving holes are assigned into a plurality of first top receiving hole groups and a plurality of second top receiving hole groups, each first top receiving hole group comprises some of the top receiving holes arranged in a line along a direction from the third sidewall of the top holding frame to the fourth sidewall of the top holding frame, each second top receiving hole group comprises some of the top receiving holes arranged in a line along a direction from the third sidewall of the top holding frame to the fourth sidewall of the top holding frame, the top receiving holes of the first top receiving hole groups are offset relative to the top receiving holes of the second top receiving hole groups.

9. The battery module of claim 8, wherein the top holding frame comprises a middle part, a plurality of connecting parts, and two end parts, the connecting parts are detachably mounted on two opposite sides of the middle part, the two end parts are respectively detachably mounted on two of the connecting parts adjacent to the two end parts, the middle part, each of the connecting parts, and each of the end parts respectively defines one of the first top receiving hole group, the middle part further defines a plurality of first notches, each of the connecting parts defines a plurality of first notches and a plurality of second notches, each of the end parts further defines a plurality of second notches, each second notch in the connecting part is aligned with one of the first notch in the middle part to form one of the top receiving hole of one of the second top receiving hole group, each second notch in the end part is aligned with one of the first notch in the connecting part to form one of the top receiving hole of another one of the second top receiving hole group.

10. The battery module of claim 9, further comprising a plurality of top electric conductive pieces, a first top electric conductive strip, and a second top electric conductive strip, wherein the first top electric conductive strip is mounted on the two first supporting rods, the second top electric conductive strip is mounted on the two second supporting rods, the anodes of the batteries are connected by the top electric conductive pieces, the anodes of the batteries adjacent to the third sidewall of the top holding frame are further connected to the first top electric conductive strip by the top electric conductive pieces, the anodes of the batteries adjacent to the fourth sidewall of the top holding frame are further connected to the second top electric conductive strip by the top electric conductive pieces.

11. The battery module of claim 7, wherein the bottom receiving holes are assigned into a plurality of first bottom receiving hole groups and a plurality of second bottom receiving hole groups, each first bottom receiving hole group comprises some of the bottom receiving holes arranged in a line along a direction from the third sidewall of the bottom holding frame to the fourth sidewall of the bottom holding frame, each second bottom receiving hole group comprises some of the bottom receiving holes arranged in a line along a direction from the third sidewall of the bottom holding frame to the fourth sidewall of the bottom holding frame, the bottom receiving holes of the first bottom receiving hole groups are offset relative to the bottom receiving holes of the second bottom receiving hole groups.

12. The battery module of claim 11, wherein the bottom holding frame comprises a middle part, a plurality of connecting parts, and two end parts, the connecting parts are detachably mounted on two opposite sides of the middle part, the two end parts are respectively detachably mounted on two of the connecting parts adjacent to the two end parts, the middle part, each of the connecting parts, and each of the end parts respectively defines one of the first bottom receiving hole group, the middle part further defines a plurality of first notches, each of the connecting parts defines a plurality of first notches and a plurality of second notches, each of the end parts further defines a plurality of second notches, each second notch in the connecting part is aligned with one of the first notch in the middle part to form one of the bottom receiving hole of one of the second bottom receiving hole group, each second notch in the end part is aligned with one of the first notch in the connecting part to form one of the bottom receiving hole of another one of the second bottom receiving hole group.

13. The battery module of claim 12, further comprising a plurality of bottom electric conductive pieces, a first bottom electric conductive strip, and a second bottom electric conductive strip, wherein the first bottom electric conductive strip is mounted on the two first supporting rods, the second bottom electric conductive strip is mounted on the two second supporting rods, the cathodes of the batteries are connected by the bottom electric conductive pieces, the cathodes of the batteries adjacent to the third sidewall of the bottom holding frame are further connected to the first bottom electric conductive strip by the bottom electric conductive pieces, the cathodes of the batteries adjacent to the fourth sidewall of the bottom holding frame are further connected to the second bottom electric conductive strip by the bottom electric conductive pieces.

14. The battery module of claim 1, wherein the bottom holding frame is made of the thermally conductive plastic.

15. The battery module of claim 14, further comprising a heat dissipating plate made of thermally conductive silicon rubber and adhered to a surface of the bottom holding frame away from the batteries.

16. The battery module of claim 1, wherein the plastic material is polyamide, the thermally conductive material is carbon fiber.
